(19) United States
(12) Patent Application Publication
(10) Pub. No.: US 2017/0227662 A1
(43) Pub. Date: Aug. 10, 2017

(54) Electronic Sensor Apparatus, Methods, and Systems

(71) Applicant: Halliburton Energy Services, Inc., Houston, TX (US)

(72) Inventor: Mikko Jaaskelainen, Katy, TX (US)

(73) Assignee: Halliburton Energy Services, Inc., Houston, TX (US)

(21) Appl. No.: 15/502,595

(22) PCT Filed: Sep. 19, 2014
(86) PCT No.: PCT/US2014/056543

§ 371 Date: Feb. 8, 2017

(51) Int. Cl. G01V 1/22; G01V 1/18; E21B 49/00; E21B 47/06; E21B 49/08

(52) U.S. Cl. CPC G01V 1/226; E21B 47/06; E21B 47/065; E21B 49/08; E21B 49/00; G01V 1/181; G01V 2210/1429

(57) ABSTRACT

A down-hole apparatus comprises a unitary seamless section defining a chamber, a clamping section to engage a fiber optic cable, actuator electronics enclosed in the chamber, and an actuator to acoustically couple the actuator electronics to the fiber optic cable. The apparatus can include a temperature sensor, a microphone, or a geophone, enclosed by the chamber. The actuator can be an acoustic emitter or a piezoelectric device. The apparatus could be battery-operated by a battery enclosed in the chamber. A sensor enclosed within the chamber could be powered by signals propagated within the fiber optic cable. Additional apparatus, methods, and systems are disclosed.

### BACKGROUND

In drilling wells for oil and gas exploration, understanding the structure and properties of the associated geological formation provides information to aid such exploration. It is useful to monitor the physical conditions inside the borehole of an oil well in order to assist in the proper operation of the well. A number of different measurements in a borehole can be performed to attain this understanding.

Further, the usefulness, efficiency, and accuracy of traditional measurements may be related to the precision or quality of the techniques and device used to attain the measurements, which may in turn be affected by the ambient borehole conditions. A borehole is a challenging environment with temperatures that can approach 150 degrees C. (302 degrees F.), 175 degrees C. (347 degrees F.), or even 200 degrees C. (392) degrees F.), and pressures that can approach 25 kpsi (172 MPa, or about 1700 atmospheres), or even 30 kpsi (207 MPa, or about 2000 atmospheres). Devices capable of withstanding these conditions while maintaining the quality and precision of measurements often require bulky seals and associated bolts, resulting in larger devices and significant labor costs.

### BRIEF DESCRIPTION OF THE DRAWINGS

The present disclosure may be better understood, and its numerous features and advantages made apparent to those of ordinary skill in the art by referencing the accompanying drawings. The use of the same reference symbols in different drawings indicates similar or identical items.

FIG. 1 depicts a block diagram of features of an example system employing an electronic sensor attached to a downhole fiber optic cable, in accordance with some embodiments.

FIG. 2 depicts a cross-section view of an example electronic sensor apparatus, in accordance with some embodiments.

FIG. 3 depicts an exploded cross-section view of an example first housing portion, actuator, actuator electronics, and sensor, in accordance with some embodiments.

FIG. 4 shows features of an example method of providing an electronic sensor apparatus, in accordance with some embodiments.

FIG. 5 depicts an example electronic sensor system comprising a plurality of electronic sensor apparatus, in accordance with some embodiments.

FIG. 6 depicts an example system at a wireline site, where the system is operable with an electronic sensor apparatus, in accordance with some embodiments.

FIG. 7 depicts an example system at a drilling site, where the system is operable with an electronic sensor apparatus, in accordance with some embodiments.

### DETAILED DESCRIPTION

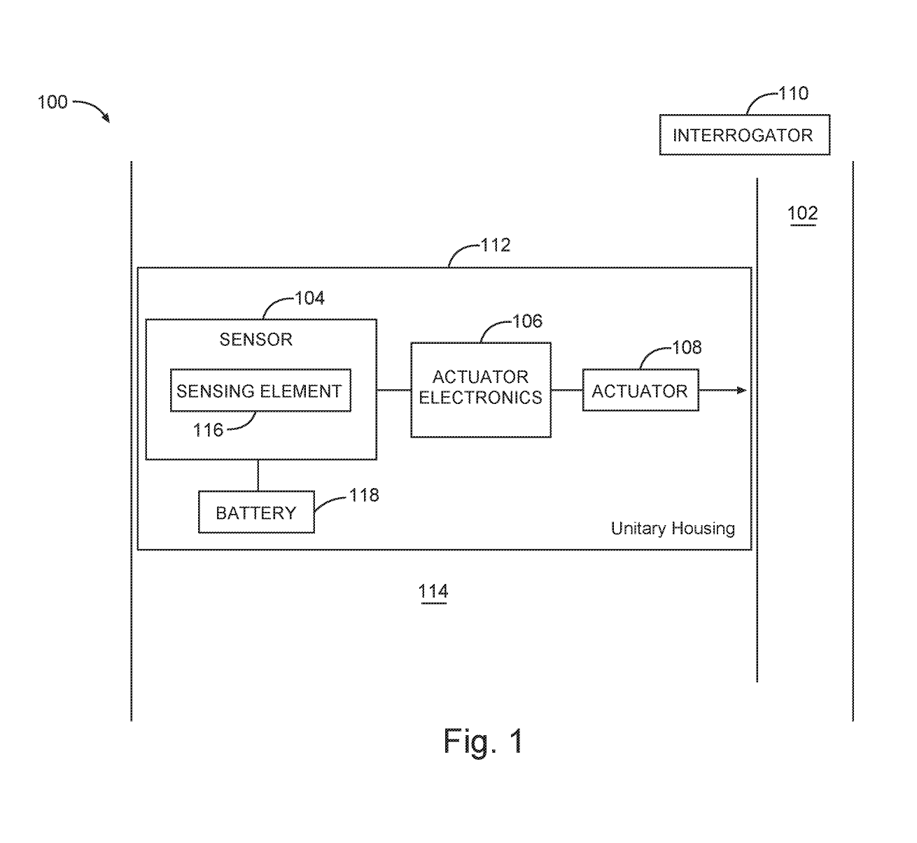

FIGS. 1-7 illustrate example techniques and apparatus for electronic sensor systems using a multi-part additive manufacturing process to create an electronic sensor apparatus comprising a unitary seamless section to withstand downhole ambient conditions without the use of bulky seals and related bolts. The unitary seamless section forms a chamber to house an actuator, actuator electronics, a sensor, a battery, or the like. The unitary seamless section is formed such that the actuator acoustically couples the actuator electronics to a fiber optic cable. As used herein, “fiber optic cable” can mean a single optical fiber or multiple optical fibers which may or may not be bonded into a single assembly. The disclosed techniques can help avoid the use of bulky packaging due to seals and associated external bolts, and increased labor costs associated with manufacturing and testing the same, resulting in lower costs and smaller device profiles.

FIG. 1 depicts a block diagram of features of an example system 100 operable to provide a mechanism to measure parameters of interest indirectly using a fiber optic cable 102. System 100 can include a sensor 104, actuator electronics 106 coupled to the sensor 104, an actuator 108 coupled to the actuator electronics 106, an interrogator 110, and an electronic sensor apparatus 112. The sensor 104 is operable to provide a measurement corresponding to a parameter at a location in a region 114, for example, a downhole environment. The sensor 104 can be realized in a number of different ways depending on the parameter to be determined by the measurement using the sensor 104. The parameter can include, but is not limited to, a chemical concentration, a pH, a temperature, or a pressure. The sensor 104 has the capability of being disposed at a location in proximity to an optical fiber, for example, fiber optic cable 102.

The sensor 104 can be located downhole at a drilling site with the interrogator 110 at the surface of the drilling site. The drilling site may be terrestrial or sea-based, Components of the system 100 may be disposed outside the well casing in cement or strapped to a production tube in a permanent installation. Components of the system 100 also may be disposed in coiled tubing that can be pushed into a horizontal area of operation. Further, the system 100 may be used with other drilling-related arrangements.

The actuator electronics 106, coupled to the sensor 104, can be structured to generate a signal correlated to the parameter in response to the measurement by the sensor 104. In at least one embodiment, the actuator electronics 106 are integrated with the sensor 104. For example, a sensing element 116 may be an integral part of the actuator electronics 106 or directly coupled to a component of the actuator electronics 106. In at least one embodiment, the sensing element 116 comprises a diaphragm directly coupled to a component of the actuator electronics 106.

The actuator 108 can be coupled to the actuator electronics 106 to receive the signal generated in response to the measurement by the sensor 104. The signal can be a compensated signal, where a compensated signal is a signal having a characteristic that corresponds to the parameter of interest for which variations in one or more other parameters is substantially corrected or removed, or for which the characteristic is isolated to the parameter of interest. The actuator 108 can be integrated with the actuator electronics 106, integrated with the actuator electronics 106 that are integrated with the sensor 104, or a separate structure coupled to the actuator electronics 106.

The actuator 108 can operate to generate a perturbation, based on the signal, to the fiber optic cable 102 with the actuator 108 arranged in proximity to the fiber optic cable 102. The actuator 108 can be arranged in proximity to the fiber optic cable 102 proximate to the location of the sensor 104. The actuator 108 can operate to generate the perturbation to the fiber optic cable 102 with the actuator 108 in contact with the fiber optic cable 102. The actuator 108 can be operated to generate the perturbation to the fiber optic cable 102 with the actuator 108 a distance from the fiber optic cable 102. The actuator 108 may be realized as a non-contact piezoelectric material, which can provide acoustic pressure to the fiber optic cable 102 rather than transferring vibrations by direct contact.

The fiber optic cable 102 can be perturbed with the fiber optic cable 102 in direct contact with the actuator 108 structured as a vibrator or with the actuator 108 structured to include a voice coil at a distance away from the fiber optic cable 102. The perturbation of the fiber optic cable 102 can be provided as a vibration of the fiber optic cable 102 or a strain induced into the fiber optic cable 102. Other perturbations may be applied such that the characteristics of the optical fiber are altered sufficiently to affect propagation of light in the fiber optic cable 102. With the effects on the light propagation related to a signal that generates the perturbation, analysis of the affected light propagation can provide data with respect to the signal that generates the perturbation.

The interrogator 110 can be structured to interrogate the fiber optic cable 102 to analyze signals propagating in the fiber optic cable 102, The interrogator 110 can couple to the fiber optic cable 102 to receive an optical signal including the effects from the perturbation of the optical fiber 125 and to extract a value of the parameter of the measurement in response to receiving the optical signal from the perturbation. In at least one embodiment, the received signal may be a backscattered optical signal.

The interrogator 110 may be structured, for example, to inject a short pulse into the fiber optic cable 102. An example of a short pulse can include a pulse of 20 nanoseconds long. As the pulse travels down the fiber optic cable 102, back scattered light is generated, Interrogating a location that is one kilometer down the fiber optic cable 102, backscattered light is received after the amount of time it takes to travel one kilometer and then come back one kilometer, which is a round trip time of about ten nanoseconds per meter. The interrogator 110 can include an interferometric arrangement. The interrogator 110 can be structured to measure frequency based on coherent Rayleigh scattering using interferometry, to measure dynamic changes in attenuation, to measure a dynamic shift of Brillioun frequency, or combinations thereof.

The interrogator 110 can be arranged with the fiber optic cable 102 to use an optical signal provided to the interrogator 110 as a result of perturbing the fiber optic cable 102 at a location along the fiber optic cable 102. An arrangement different from using an optical signal backscattered from the perturbation can be utilized. For example, the interrogator 110 can be structured to include a fiber Bragg grating disposed in the fiber optic cable 102 in vicinity of the actuator 115, a non-wavelength selective in-line mirror disposed in the fiber optic cable 102 in vicinity of the actuator 115, intrinsic Fabry-Perot interferometers as a mode of interrogation from a fiber Brag gratings placed apart in the fiber optic cable 102 such that each fiber Bragg grating is in vicinity of a respective actuator 115, Fizeau sensors in the fiber optic cable 102, a second fiber optic cable to transmit an optical signal from a perturbation of the fiber optic cable 102 to a detection unit of the interrogator 110, or other arrangements to propagate a signal, representative of a measurement, in a fiber optic cable to an interrogation unit to analyze the signal to extract a value of a parameter that is the subject of the measurement.

The electronic sensor apparatus 112, comprises a unitary seamless section, formed via a multi-part additive manufacturing process, that can house the sensor 104, the actuator electronics 106, the actuator 108, a battery 118, or the like. The electronic sensor apparatus 112 is pressure-sealed so as to protect components in a chamber of the unitary seamless section from ambient elements, without the use of seals and associated bolts that would add bulk to the device.

The unitary seamless section of the electronic sensor apparatus 112 is composed of a material such that the electronic sensor apparatus 112 can withstand the ambient down-hole pressure and temperature. The electronic sensor apparatus 112 can be attached to the fiber optic cable 102. In at least one embodiment, system 100 is a distributed acoustic sensing (DAS) system, and the sensor 104 is a temperature sensor housed in the chamber of the electronic sensor apparatus 112.

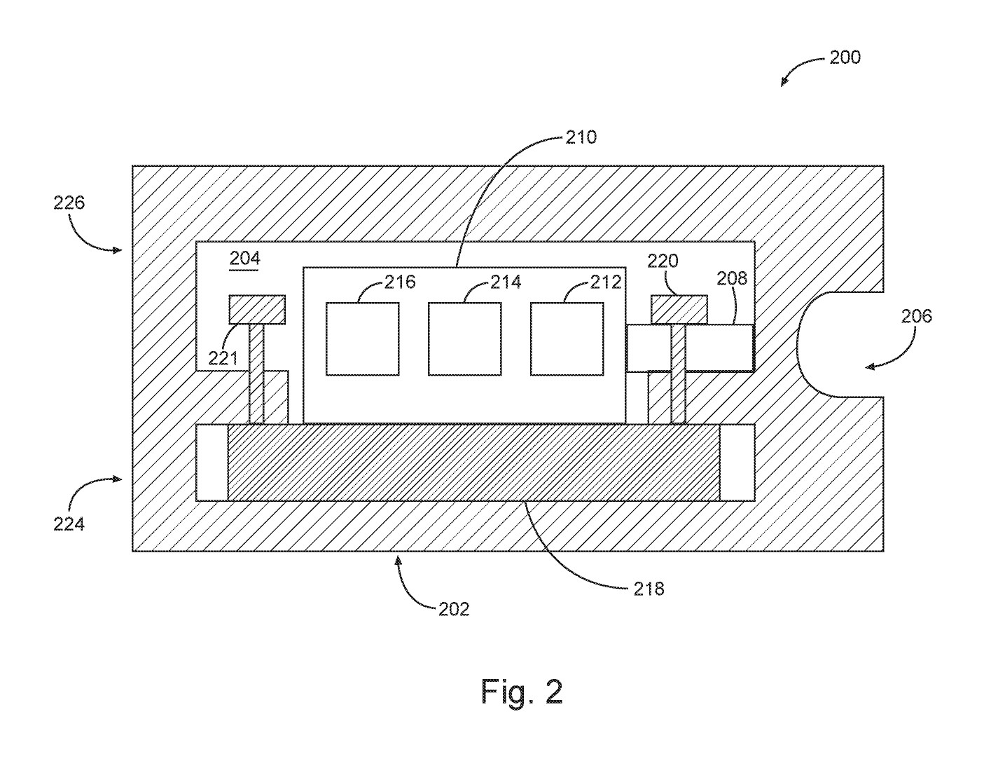

FIG. 2 depicts a cross-section view of an example electronic sensor apparatus 200, in accordance with some embodiments. The electronic sensor apparatus 200 includes a unitary seamless section 202 defining a chamber 204, and a clamping section 206 to engage a fiber optic cable via clamps, screws, a combination of these, or the like. The unitary seamless section 202 of the electronic sensor apparatus 200 is formed via a multipart additive manufacture process in which a first housing portion 224 is formed, and then a second housing portion 226 is formed on the first housing portion 224. The resulting unitary seamless section 202 is pressure-sealed, such that the chamber 204 isolates an actuator 208 and electronic components 210 from ambient conditions in a downhole environment. The electronic components 210 can include, for example, actuator electronics 212, a sensor 214, a battery 216, a combination of these, or the like.

The actuator 208 acoustically couples the actuator electronics 212 to the fiber optic cable, such that parameters measured by the sensor 214 may be communicated. For example, in one embodiment, the sensor 214 is a temperature sensor that includes a circuit to translate the measured temperature to an acoustic frequency that is detected with a DAS system. In other embodiments, the sensor 214 is any type of sensor capable of exciting the actuator 208, for example, a geophone, an accelerometer, or a microphone. Further, some embodiments comprise more than one sensor 214. For example, multiple geophones may be used to capture the directionality of wave fields by using different planes as the primary axis of sensing, in at least one embodiment, the actuator 208 comprises an acoustic emitter. In at least one embodiment, the actuator 208 comprises a piezoelectric device.

In at least one embodiment, a base 218 is provided in the chamber 204 of the unitary seamless section 202, such that one or more of the electronic components 210 may be attached to or otherwise secured in the base 218, In one embodiment, the base 218 is held in place within the chamber 204 via any of a variety of fasteners 220, 221. In another embodiment, the base 218 is formed via the additive manufacturing process. In a further embodiment, the base 218 is formed as part of the unitary seamless section. In at least one embodiment, the base 218 comprises metal, plastic, a combination thereof, or the like.

In at least one embodiment, one or more of the electronic components are battery-powered by the battery 216. Battery-powered devices can be maintained in a power save mode until activated by an acoustic signal. For example, in at least one embodiment, the actuator 208 is capable of bidirectional communication, such that the actuator 208 can pick up an acoustic signal to activate the battery-powered electronic components 210. The electronic components 210 could be powered up acoustically during deployment or during the service life in the well, or have logic that would make periodic measurements to save power. In some embodiments, one or more of the electronic components 210 housed within the chamber 204 is electrically powered by signals propagated within the fiber optic cable. For example, the fiber optic cable could include an electrical conductor and use electro-magnetic radiation or inductive coupling to power one or more of the electronic components 210.

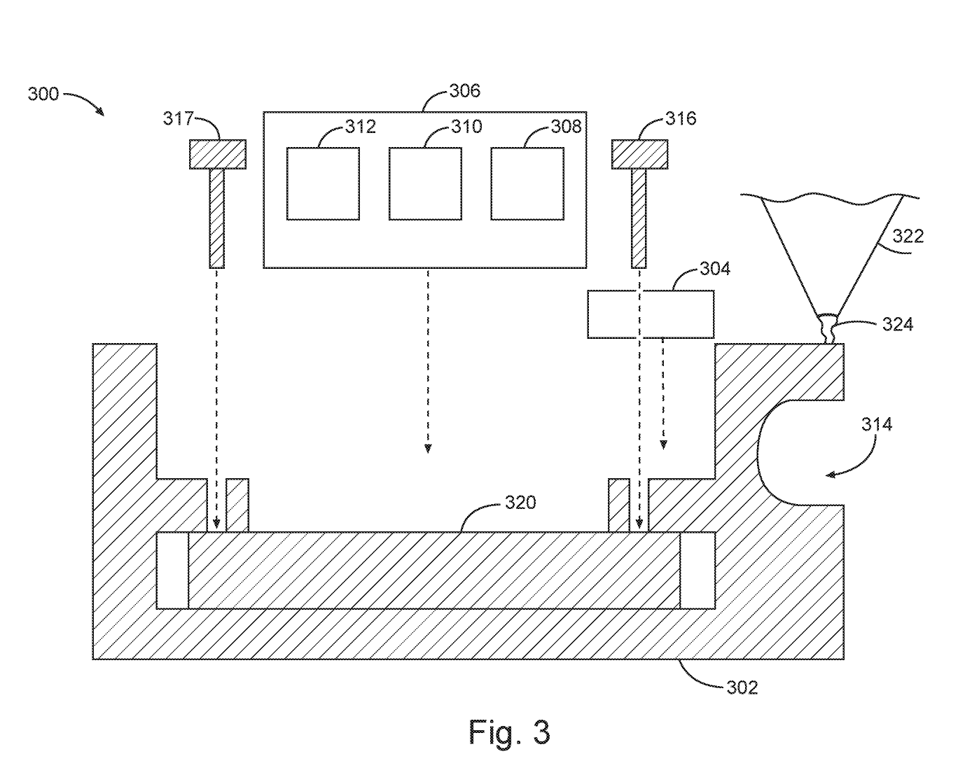

FIG. 3 depicts an exploded cross-section view 300 of an example first housing portion 302, actuator 304, and electronic components 306, in accordance with some embodiments. The first housing portion 302 represents one portion of a unitary seamless section defining a chamber to protect the actuator 304 and electronic components 306 (e.g., actuator electronics 308, a sensor 310, a battery 312, or the like) from ambient downhole conditions. The first housing portion 302 is formed using an additive manufacturing process.

Additive manufacturing, also known to some of ordinary skill in the art as “3D printing” is the process of laying down successive layers of material to create a three-dimensional object. Any of a variety of additive manufacturing processes may be used to create the first housing portion 302. For example, fused deposition modeling (FDM), electron beam freeform fabrication (EBF³), direct metal laser sintering (DMLS), electron-beam melting (IBM), selective laser melting (SLM), selective heat sintering (SHS), selective laser sintering (SLS), plaster-based 3D printing (PP), laminated object manufacturing (LOM), stereolithography (SLA), digital light processing (DLP), or the like.

In the illustrated embodiment, a clamping portion 314 is formed on the first housing portion 302. In at least one embodiment, the clamping portion 314 is formed via an additive manufacturing process. In another embodiment, the clamping portion 314 is attached to the first housing portion 302 via any of a variety of fasteners. The clamping portion 314 is configured to engage a fiber optic cable (via clamps, screws, a combination of these, or the like) such that the actuator 304 acoustically couples the actuator electronics 308 to the fiber optic cable.

The actuator 304 and electronic components 306 are inserted into the first housing portion 302 and secured via any of a variety of fasteners 316, 317. In at least one embodiment, the first housing portion 302 is formed to comprise a base 320 that engages and secures one or more of the electronic components 306, for example, the sensor 310. In different embodiments, the first housing portion 302 may comprise any of a variety of shapes and features to facilitate seating of the actuator 304 and the electronic components 306. Additionally, in some embodiments, the clamping portion 314 is not formed on or attached to the first housing portion 302.

A second housing portion is formed at a surface of the first housing portion 302, such that the first housing portion 302 and the second housing portion form the unitary seamless section. The second housing portion is formed via an additive manufacturing process, in which a tool 322 deposits a material 324 layer by layer on the first housing portion 302. In at least one embodiment, the same type of additive manufacturing process is used for the second housing portion as was used for the first housing portion 302. In at least one embodiment, the same material is used for both the first housing portion and the second housing portion 302, for example, metal.

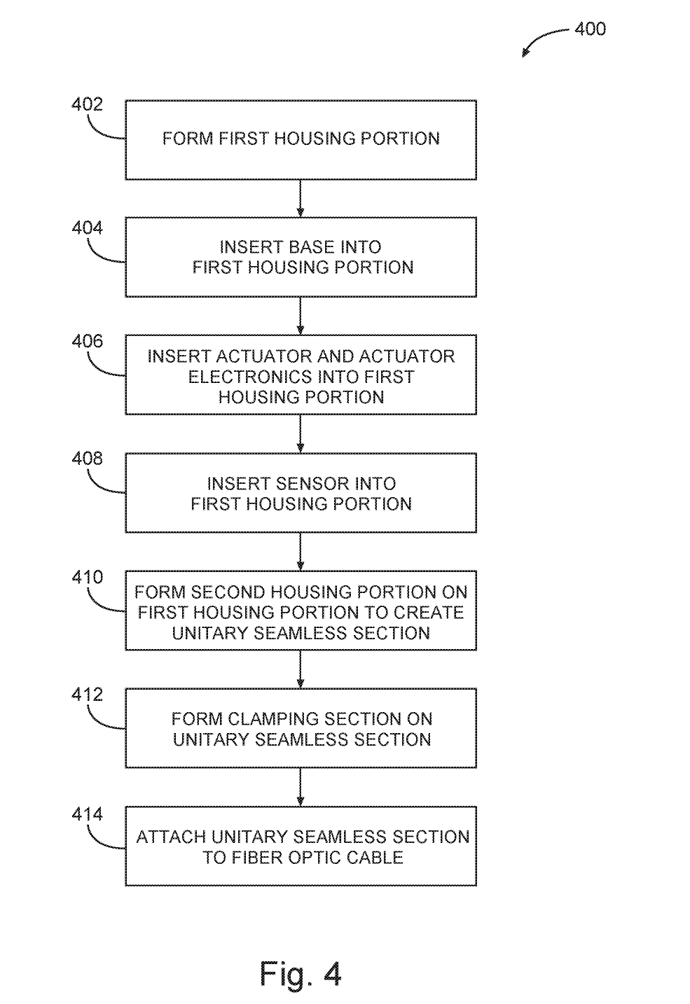

FIG. 4 shows features of an example method 400 of providing an electronic sensor apparatus, in accordance with some embodiments. For purposes of illustration, the method 400 is described with reference to FIGS. 2. Thus, referring now to FIGS. 2 and 4, it can be seen that at block 402, a first housing portion 224 is formed via an additive manufacturing process. The additive manufacturing process forms the first housing portion 224 from a digital model by depositing thin layers of material one after another, until the three-dimensional first housing portion 224 is complete. In at least one embodiment, the first housing portion 224 comprises metal.

At block 404, a base 218 is inserted into the first housing portion 224. In at least one embodiment, the base 218 is configured to receive one or more of the electronic components 210. For example, in at least one embodiment, the base 218 secures the sensor 214 within the chamber 204. The base 218 may be attached to the first housing portion 202. using any of a variety of fasteners. The base 218 may comprise any of a variety of materials, for example, plastic, metal, a combination of these, and the like. In at least one embodiment, the base 218 is formed via an additive manufacturing process. In at least one embodiment, the base 218 is formed as part of the first housing portion 224, rather than formed separately and inserted into the first housing portion 202.

At block 406, an actuator 208 and actuator electronics 212 are inserted into the first housing portion 224. The actuator 208 may comprise, for example, an acoustic emitter, a piezoelectric device, or the like. The actuator 208 is inserted into the first housing portion 224 such that the actuator 208 can acoustically couple the actuator electronics 212 to a fiber optic cable. In at least one embodiment, the actuator electronics 212 are seated on the base 218. in at least one embodiment, the actuator electronics 212 are attached to the base 218 outside of the first housing portion 224, and the assembly is then inserted into the first housing portion 224.

At block 408, a sensor 214 is inserted into the first housing portion 224. The sensor 214 may be, for example, a temperature sensor, a microphone, a geophone, a combination of these, or the like. In some embodiments, multiple sensors may be inserted into the first housing portion 224. In at least one embodiment, the sensor 214 is fastened to the first housing portion 224. In some embodiments, the base 218 mechanically couples the sensor 214 to the first housing portion 224. In at least one embodiment, the sensor 214 is attached to the base 218 outside of the first housing portion 224, and the assembly is then inserted into the first housing portion 224. In such an embodiment, the assembly may further include other electronic components 210 in addition to the sensor 214. In some embodiments, a battery 216 or other electronic components 210 are inserted into the first housing portion 224 in addition to the actuator 208, actuator electronics 212, and the sensor 214.

At block 410, a second housing portion 226 is formed on the first housing portion 224 to create a unitary seamless section 202. The second housing portion 226 is formed via an additive manufacturing process to create a pressure-sealed chamber 204, such that electronic components 210 enclosed by the chamber 204 are isolated from ambient downhole conditions. In at least one embodiment, the same type of additive manufacturing process is used for both the first housing portion 224 and the second housing portion 226. In some embodiments, the same material is used for both the first housing portion 224 and the second housing portion 226.

At block 412, a clamping section 206 is formed on the unitary seamless section 202 to engage the fiber optic cable, attaching the unitary seamless section 202 to the fiber optic cable via clamps, screws, a combination of these, or the like. In at least one embodiment, the clamping section 206 is formed via an additive manufacturing process. In some embodiments, the clamping section 206 is formed as part of the first housing section 224 or the second housing portion 226. In at least one embodiment, a first part of the clamping section 206 is formed on the first housing portion 224 and a second part of the clamping section 206 is formed on the second housing portion 226.

At block 414, the unitary seamless section 202 is attached to the fiber optic cable via clamping section 206. The unitary seamless section 202. is attached to the fiber optic cable such that the actuator 208 acoustically couples the actuator electronics 212 to the fiber optic cable. Measured parameters can then be communicated from the sensor 214 to the fiber optic cable, via the actuator electronics 212 and the actuator 208. Further, in at least one embodiment, the unitary seamless section 202 is attached to the fiber optic cable such that one or more of the electronic components 210 (for example, the sensor 214) is powered by signals propagated within the fiber optic cable. That is, in at least one embodiment, the fiber optic cable includes an electrical conductor and uses electro-magnetic radiation or inductive coupling to power one or more of the electronic components 210 (for example, the sensor 214).

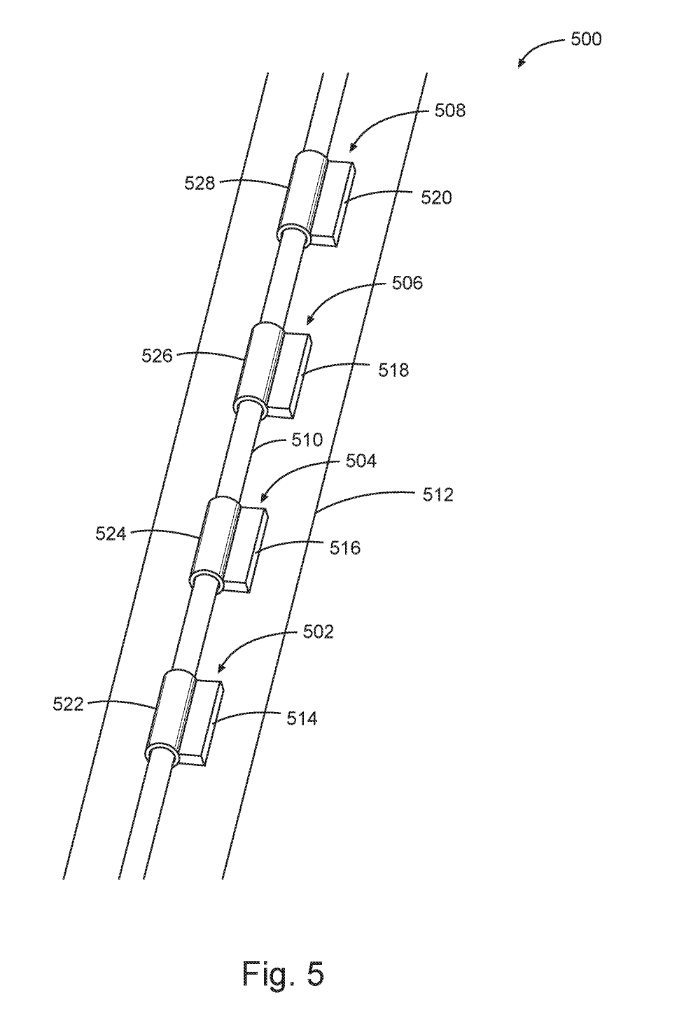

FIG. 5 depicts an example electronic sensor system 500 comprising a plurality of electronic sensor apparatus 502, 504, 506, 508, in accordance with some embodiments, Each of the plurality of electronic sensor apparatus 502-508 is attached to a downhole fiber optic cable 510 within a borehole 512. While the illustrated embodiment depicts four electronic sensor apparatus 502-508, other embodiments may comprise more electronic sensor apparatus, while still other embodiments may comprise less electronic sensor apparatus.

Each electronic sensor apparatus 502-508 comprises actuator electronics (e.g., actuator electronics 212 of FIG. 2) enclosed in a chamber of a unitary seamless section 514, 516, 518, 520. Further, each electronic sensor apparatus 502-508 comprises a clamping section 522, 524, 526, 528 to receive the fiber optic cable 510 and couple to the fiber optic cable 510 using, for example, clamps, screws, a combination of these, or the like. Additionally, each electronic sensor apparatus 502-508 comprises an actuator (e.g., actuator 208 of FIG. 2) to acoustically couple the actuator electronics to the fiber optic cable 510 when the clamping section 522-528 is coupled to the fiber optic cable 510. In at least one embodiment, the actuator of at least one of the plurality of apparatus 502-508 is in mechanical contact with the fiber optic cable 510. At least one electronic sensor apparatus of the plurality of electronic sensor apparatus 502-508 comprises an electrical sensor enclosed in the chamber of the unitary seamless section 514-520 and electrically coupled to the actuator electronics.

In at least one embodiment, the system 500 may be used in combination with a Time Division Multiplexing (TDM) system, such as a DAS system to collect measurements along the length of the fiber optic cable 510. Since a TDM system will differentiate sensors by time of flight as well as frequency, in at least one embodiment, a first electronic sensor apparatus 502 and a second electronic sensor apparatus 504 are separated by a distance such that both the first apparatus and the second apparatus 504 may operate at the same frequency, while avoiding crosstalk between the first apparatus and the second apparatus. In at least one embodiment, the first electronic sensor apparatus 502 operates at a different frequency than the second electronic sensor apparatus to avoid crosstalk.

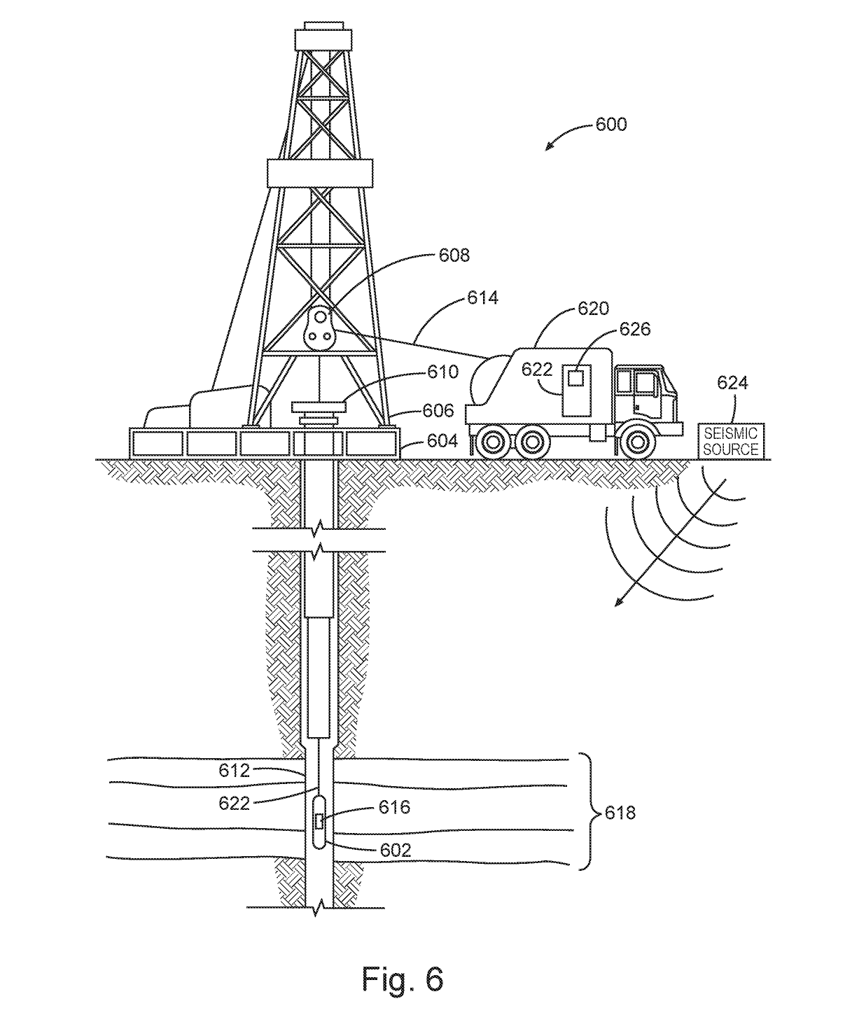

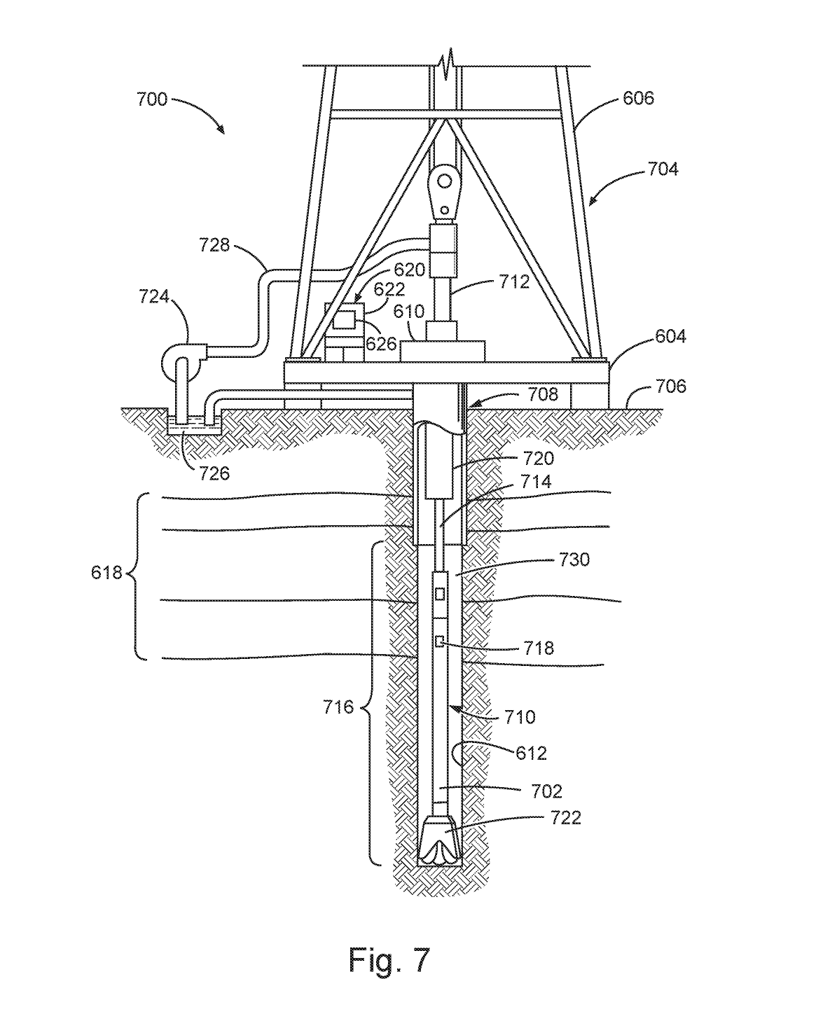

FIG. 6 is a diagram showing a wireline system 600 embodiment, and FIG. 7 is a diagram showing a drilling rig system 700 embodiment. The systems 600, 700 may thus comprise portions of a wireline logging tool body 602 as part of a wireline logging operation, or of a down hole tool 702 as part of a down hole drilling operation.

FIG. 6 illustrates a well used during wireline logging operations. In this case, a drilling platform 604 is equipped with a derrick 606 that supports a hoist 608.

Drilling oil and gas wells is commonly carried out using a string of drill pipes connected together so as to form a drillstring that is lowered through a rotary table 610 into a wellbore or borehole 612. Here it is assumed that the drillstring has been temporarily removed from the borehole 612 to allow a wireline logging tool body 602, such as a probe or sonde, to be lowered by wireline or logging cable 614 (e.g., slickline cable) into the borehole 612. Typically, the wireline logging tool body 602 is lowered to the bottom of the region of interest and subsequently pulled upward at a substantially constant speed. The tool body 602 may include an electronic sensor apparatus 616 (which may include any one or more of the elements of FIGS. 1-3 and 5).

During the upward trip, at a series of depths various instruments (e.g., the electronic sensor apparatus 616 included in the tool body 602) may be used to perform measurements on the subsurface geological formations 618 adjacent to the borehole 612 (and the tool body 602). The measurement data can be communicated to a surface logging facility 620 for processing, analysis, and/or storage. The processing and analysis may include measurement of Doppler shift and determination of acoustic/seismic wave velocity. The logging facility 620 may be provided with electronic equipment for various types of signal processing, which may be used by any one or more of the components of the electronic sensor apparatus 616. Similar formation evaluation data may be gathered and analyzed during drilling operations (e.g., during LWD/MWD operations, and by extension, sampling while drilling).

In some embodiments, the tool body 602 is suspended in the wellbore by a wireline cable 614 that connects the tool to a surface control unit (e.g., comprising a workstation 622). The tool may be deployed in the borehole 612 on coiled tubing, jointed drill pipe, hard wired drill pipe, or any other suitable deployment technique.

A seismic source 624 is located on the surface. The seismic source 624 may be configured to transmit seismic waves into the geologic formation. The workstation 622 may include a controller 626 that controls operation of the seismic source 624. The seismic source 624 may be considered an acoustic source as well since it generates low frequency sound waves.

Referring to FIG. 7, it can be seen how a system 700 may also form a portion of a drilling rig 704 located at the surface 706 of a well 708. The drilling rig 704 may provide support for a drillstring 710. The drillstring 710 may operate to penetrate the rotary table 610 for drilling the borehole 612 through the subsurface formations 618. The drillstring 710 may include a Kelly 712, drill pipe 714, and a bottom hole assembly 716, perhaps located at the lower portion of the drill pipe 714. As can be seen in the figure, the drillstring may include an electronic sensor apparatus 718 (which may include any one or more of the elements of FIGS. 1-3 and 5).

The bottom hole assembly 716 may include drill collars 720, a down hole tool 702, and a drill bit 722. The drill bit 722 may operate to create the borehole 612 by penetrating the surface 706 and the subsurface formations 618. The down hole tool 702 may comprise any of a number of different types of tools including MWD tools, LWD tools, and others.

During drilling operations, the drill string 710 (perhaps including the Kelly 712, the drill pipe 714, and the bottom hole assembly 716) may be rotated by the rotary table 610. Although not shown, in addition to, or alternatively, the bottom hole assembly 716 may also be rotated by a motor (e.g., a mud motor) that is located down hole. The drill collars 720 may be used to add weight to the drill bit 722. The drill collars 720 may also operate to stiffen the bottom hole assembly 716, allowing the bottom hole assembly 716 to transfer the added weight to the drill bit 722, and in turn, to assist the drill bit 722 in penetrating the surface 706 and sub surface formations 618.

During drilling operations, a mud pump 724 may pump drilling fluid (sometimes known by those of ordinary skill in the art as “drilling mud”) from a mud pit 726 through a hose 728 into the drill pipe 714 and down to the drill bit 722. The drilling fluid can flow out from the drill bit 722 and be returned to the surface 706 through an annular area 730 between the drill pipe 714 and the sides of the borehole 612. The drilling fluid may then be returned to the mud pit 726, where such fluid is filtered. In some embodiments, the drilling fluid can be used to cool the drill bit 722, as well as to provide lubrication for the drill bit 722 during drilling operations. Additionally, the drilling fluid may be used to remove subsurface formation cuttings created by operating the drill bit 722.

The workstation 622 and the controller 626 may include modules comprising hardware circuitry, a processor, and/or memory circuits that may store software program modules and objects, and/or firmware, and combinations thereof, as desired by the architect of the electronic sensor apparatus 616 and as appropriate for particular implementations of various embodiments. For example, in some embodiments, such modules may be included in an apparatus and/or system operation simulation package, such as a software electrical signal simulation package, a power usage and distribution simulation package, a power/heat dissipation simulation package, and/or a combination of software and hardware used to simulate the operation of various potential embodiments.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. it is therefore evident that the particular embodiments disclosed above may be altered or modified and all such variations are considered within the scope of the disclosed subject matter. Accordingly, the protection sought herein is as set forth in the claims below.

We claim:

1. An apparatus, comprising:
a unitary seamless section defining a chamber;
a clamping section to engage a fiber optic cable;
actuator electronics enclosed in the chamber; and
an actuator to acoustically couple the actuator electronics to the fiber optic cable.

2. The apparatus of claim 1, further comprising at least one of: a temperature sensor, a microphone, or a geophone, enclosed by the chamber.

3. The apparatus of claim, wherein the actuator comprises an acoustic emitter.

4. The apparatus of claim I. wherein the actuator comprises a piezoelectric device.

5. The apparatus of claim 1, further comprising a battery enclosed in the chamber

6. The apparatus of claim 1, wherein a sensor enclosed in the chamber is to be powered by signals propagated within the fiber optic cable.

7. The electronic sensor of claim I. wherein the unitary seamless section comprises metal.

8. A method, comprising:
forming a first housing portion via additive manufacturing;
inserting actuator electronics into the first housing portion;
inserting an actuator into the first housing portion; and
forming a second housing portion via additive manufacturing on the first housing portion, such that the first housing portion and the second housing portion form a unitary seamless section defining a chamber enclosing the actuator and the actuator electronics, wherein the unitary seamless section is formed such that the actuator acoustically couples the actuator electronics to a fiber optic cable when the fiber optic cable is engaged with the unitary seamless section.

9. The method of claim 8, further comprising:
inserting a sensor into the first housing portion, such that the sensor is enclosed in the chamber after the second housing portion is formed.

10. The method of claim 9, further comprising:
fastening the sensor to the first housing portion.

11. The method of claim 9, further comprising inserting a base into the first housing portion to mechanically couple the sensor to the first housing portion.

12. The method of claim 9, further comprising:
attaching the unitary seamless section to the fiber optic cable.

13. The method of claim 8, further comprising:
forming a clamping section on at least one of the first housing portion or the second housing portion to engage the fiber optic cable via clamps.

14. The method of claim 8, further comprising:
forming a clamping section on the unitary seamless section to engage the fiber optic cable via clamps.

15. A system, comprising:
a downhole fiber optic cable; and
a plurality of apparatus disposed at the downhole fiber optic cable, each of the apparatus comprising:
a clamping section to receive a fiber optic cable;
a unitary seamless section defining a chamber;
actuator electronics enclosed in the chamber; and
an actuator to acoustically couple the actuator electronics to the fiber optic cable.

16. The system of claim 15, wherein a first apparatus of the plurality of apparatus is to operate at a different frequency than a second apparatus of the plurality of apparatus.

17. The system of claim 15, Wherein a first apparatus of the plurality of apparatus is to operate at a same frequency as a second apparatus of the plurality of apparatus, the first apparatus and the second apparatus separated by at least a distance to provide less than a. selected level of crosstalk between the first apparatus and the second apparatus under specified operating conditions.

18. The system of claim 15, wherein at least one apparatus of the plurality of apparatus further comprises an electrical sensor enclosed in the chamber, the electrical sensor electrically coupled to the actuator electronics.

19. The system of claim 15, wherein the unitary seamless section of at least one of the plurality of apparatus is formed using a multi-part additive manufacturing process.

20. The system of claim 15, wherein the actuator of at least one of the plurality of apparatus is in mechanical contact with the fiber optic cable.

21. The system of claim 15, wherein the clamping section is to couple to the fiber optic cable via at least one of clamps or screws.
